(19) United States
(12) Patent Application Publication
(10) Pub. No.: US 2007/0064409 A1
(43) Pub. Date: Mar. 22, 2007

(54) ELONGATED ILLUMINATION DEVICE HAVING UNIFORM LIGHT INTENSITY DISTRIBUTION

(75) Inventor: George R. Hulse, Arlington Heights, IL (US)

Correspondence Address: STITES & HARBISON, PLLC, 400 W MARKET ST, SUITE 1800, LOUISVILLE, KY, 40202-3352, US

(73) Assignee: ILIGHT TECHNOLOGIES, INC., Chicago, IL (US)

(21) Appl. No.: 11/533,170

(22) Filed: Sep. 19, 2006

Related U.S. Application Data
(60) Provisional application No. 60/719,130, filed on Sep. 21, 2005.

(51) Int. Cl. F21V 9/16; F21V 9/00; F21V 5/00

(52) U.S. Cl. 362/84; 362/230; 362/246; 362/331

(57) ABSTRACT

An illumination device has an elongated array of point light sources, a focusing rod, and a diffusing rod. The focusing rod is positioned adjacent and along the array of point light sources, for focusing light into an elongated light distribution pattern. The diffusing rod is positioned adjacent and along the focusing rod for receiving the focused light and diffusing the light into an essentially uniform light intensity distribution pattern, for simulating a tubular lamp having a uniform light intensity distribution. The illumination device may further have a color-converting member for converting a light of a first color emitted by the array of point light sources to a light of a second color, such that the light emitted by the illumination device is of a color that is a combination of the light of a first color and the light of a second color.

### CROSS-REFERENCE TO RELATED APPLICATIONS

The present application claims priority to U.S. Provisional Patent Application Ser. No. 60/719,130 filed on Sep. 21, 2005, the entire disclosure of which is incorporated herein by reference.

### BACKGROUND OF THE INVENTION

The present invention relates to an elongated illumination device having a uniform light intensity distribution, such as a neon tube, a tubular fluorescent lamp, or the like.

Neon tube lighting, which is produced by the electrical stimulation of the electrons in the low-pressure neon gas-filled glass tube, has been a main stay in advertising and for signage. A characteristic of neon lighting is that the tubing encompassing the gas has an even glow over its entire length irrespective of the viewing angle. This characteristic makes neon lighting adaptable for many advertising applications, including script writing and designs, because the glass tubing can be fabricated into curved and twisted configurations simulating script writing and intricate designs. The even glow of neon lighting being typically devoid of hot spots allows for advertising without visual and unsightly distractions. Thus, any illumination device that is developed to duplicate the effects of neon lighting must also have even light distribution over its length and about its circumference. Equally important, such lighting devices must have a brightness that is at least comparable to neon lighting. Further, since neon lighting is a well-established industry, a competitive lighting device must be lightweight and have superior “handleability” characteristics in order to make inroads into the neon lighting market. Neon lighting is recognized as being fragile in nature. Because of the fragility and heavy weight, primarily due to its supporting infrastructure, neon lighting is expensive to package and ship. Moreover, it is extremely awkward to initially handle, install, and/or replace. Any lighting device that can provide those previously enumerated positive characteristics of neon lighting, while minimizing its size, weight, and handleability shortcomings, will provide for a significant advance in the lighting technology.

Tubular fluorescent lamps also produce illumination through the electrical simulation of electrons in a low-pressure gas-filled glass tube. Similar to neon lighting, tubular fluorescent lamp lighting also has a uniform light intensity distribution over its entire length irrespective of the viewing angle. Advantageously, the light output and elongated geometry make tubular fluorescent lamp lighting particularly useful for shadow-free, general task illumination.

The recent introduction of lightweight and breakage resistant point light sources, as exemplified by high-intensity light-emitting diodes (LEDs), have shown great promise to those interested in elongated illumination devices having uniform light intensity distribution, such as neon tube and tubular fluorescent lighting. However, uniformity and brightness have proven to be difficult characteristics to achieve, as attempts to simulate neon tube or tubular fluorescent lighting have largely been stymied by the tradeoffs between brightness and light distribution to promote uniformity.

In an attempt to address some of the shortcomings, commonly assigned U.S. Pat. Nos. 6,592,238 and 6,953,262, which are incorporated in their entirety herein by reference, each describes an illumination device comprising a profiled rod of material having waveguide properties that preferentially diffuses or scatters light entering one surface (“light-receiving surface”) so that the resulting light intensity pattern emitted by another surface of the rod (“light-emitting surface”) is elongated along the length of the rod. A light source extends along and is positioned adjacent the light-receiving surface and spaced from the light-emitting surface a distance sufficient to create an elongated light intensity pattern with a major axis along the length of the rod and a minor axis that has a width that covers substantially the entire circumferential width of the light-emitting surface. In a preferred arrangement, the light source is a string of point light sources spaced a distance apart sufficient to permit the mapping of the light emitted by each point light source into the rod so as to create elongated and overlapping light intensity patterns along the light-emitting surface and circumferentially about the surface so that the collective light intensity pattern is perceived as being uniform over the entire light-emitting surface.

One of the essential features of the illumination device described and claimed in U.S. Pat. Nos. 6,592,238 and 6,953,262 is the uniformity and intensity of the light emitted by the illumination device. This objective is achieved primarily through the use of a “leaky waveguide” diffusing rod. A “leaky waveguide” is a structural member that functions both as an optical waveguide and light scattering member. As a waveguide, it tends to preferentially direct light entering the waveguide, including the light entering a surface thereof, along the axial direction of the waveguide, while as a light scattering member, it urges the light out of an opposite surface of the waveguide. As a result, what is visually perceived is an elongated light pattern being emitted along the light-emitting surface of the waveguide.

A problem with using LEDs for simulating neon tubes, tubular fluorescent lamps, and the like is that the available visible color spectrum, including white lighting for general task illumination, is limited by the finite availability of LED colors. Therefore, in commonly assigned U.S. Pat. No. 7,011,421; U.S. patent application Ser. No. 11/025,019; and U.S. patent application Ser. No. 11/383,307, which are also incorporated herein by reference, illumination devices are described that use fluorescent dyes, phosphorescent dyes, and other color-converting pigments for emitting light and colors that cannot ordinarily be achieved by the use of LEDs alone without significant increase in cost or complexity of the illumination device.

In any event, there remains a need for improved and alternate constructions for an elongated illumination device having a uniform light intensity distribution, such as neon tubes and tubular fluorescent lamps (“tubular lamps”), and the like. Further, there remains a need for illumination devices having uniform light intensity distribution in colors that cannot ordinarily be achieved by the use of LEDs alone without significant increase in cost or complexity.

### BRIEF SUMMARY OF THE INVENTION

These needs, and others, are met by the elongated illumination device of the invention, which utilizes a focusing rod between an elongated array of point light sources and a diffusing rod to focus light from the array of point light sources into an elongated light distribution pattern. The diffusing rod then diffuses the elongated light distribution pattern into an essentially uniform light distribution pattern along the length of the diffusing rod to create a glowing illumination effect in the diffusing rod. Advantageously, the invention provides for simpler and less expensive manufacturing techniques, less expensive component costs, and a shorter profile.

Generally described, an illumination device according to the invention has an elongated array of light-emitting diodes (LEDs), a focusing rod, and a diffusing rod. The LEDs of the elongated array are spaced a predetermined distance from one another. The focusing rod has a light-receiving surface and an opposing light-emitting surface. The focusing rod is positioned such that the light-receiving surface is adjacent and along the array of point light sources for receiving light emitted by the array of point light sources, focusing the light into an elongated light-distribution pattern, and emitting the focused light along the light-emitting surface. The diffusing rod is positioned adjacent and along the light-emitting surface for receiving light emitted along the light-emitting surface, diffusing the light into an essentially uniform light intensity distribution pattern, and emitting the diffused light for simulating a tubular lamp having a uniform light intensity distribution.

According to an aspect of the invention, the focusing rod and the diffusing rod may have substantially circular cross-sectional profiles.

According to another aspect of the invention, the focusing rod has a predetermined focal length, and the focusing rod is spaced a distance substantially equal to the predetermined focal length from the array of point light sources.

According to yet another aspect of the invention, the illumination device further has a housing having a pair of side walls and a bottom wall connecting the side walls. The side walls and bottom wall define an open-ended channel in which the array of point light sources, the focusing rod, and the diffusing rod are received. The diffusing rod may protrude from the channel for simulating a surface of a tubular lamp. Advantageously, the side walls may have reflective interior surfaces for redirecting incident light from the array of point light sources into the focusing rod, and the side walls may have light-absorbing exterior surfaces.

Still further, the array of point light sources may be mounted on a circuit board, and the circuit board may have a reflective surface for further directing light into the focusing rod.

In another aspect of the invention, the illumination device further has a sleeve encasing the housing, the array of point light sources, the focusing rod and the diffusing rod to maintain the components relative to one another and to provide a water-tight barrier for the components. The sleeve may be made of a light-transmitting flexible plastic material.

In yet another aspect of the invention, the illumination device has a spacer member positioned between the focusing rod and the diffusing rod. The spacer member may have double-sided adhesive properties for holding the focusing rod and the diffusing rod together.

According to yet another aspect of the invention, the illumination device further has a color-converting member composed of a matrix of substantially translucent material doped with a color-converting material, and the array of point light sources is an array of LEDs for emitting a light of a first color. In one embodiment, the color-converting member is positioned between the focusing rod and the diffusing rod for intercepting a portion of the light emitted by the focusing rod. In another embodiment, the color-converting member is positioned between the array of LEDs and the focusing rod for intercepting a portion of the light emitted by the array of LEDs. In both embodiments, the color-converting member converts a portion of the light of the first color emitted by the array of LEDs into a light of a second color. The light emitted by the illumination device will be of a color that is a combination of the light of a first color and the light of a second color.

Finally, in yet another aspect of the invention, the side walls of the housing are contoured to hold the components of the illumination device in position with respect to each other.

### BRIEF DESCRIPTION OF THE FIGURES

FIG. 1 is a perspective view of a first exemplary elongated illumination device having a uniform light intensity distribution according to the invention.

FIG. 2 is an end view of the exemplary illumination device of FIG. 1.

FIG. 3 is a side-sectional view of the exemplary illumination device of FIG. 1.

FIG. 4 illustrates how the focal length of a ball lens is calculated.

FIG. 5 is a ray trace diagram illustrating the focusing of light emitted by an LED passing though a focusing rod and a diffusing rod.

FIG. 6 is a light distribution diagram illustrating an elongated light distribution pattern emitted along a focusing rod.

FIG. 7 is an end view of a second exemplary elongated illumination device having a uniform light intensity distribution according to the invention.

FIG. 8 is an end view of a third exemplary elongated illumination device having a uniform light intensity distribution according to the invention.

FIG. 9 is a side-sectional view of the exemplary illumination device of FIG. 8.

FIG. 10 is an end view of a fourth exemplary elongated illumination device having a uniform light intensity distribution according to the invention.

FIG. 11 is a side-sectional view of the exemplary illumination device of FIG. 10.

FIG. 12 is an end view of a fifth exemplary elongated illumination device having a uniform light intensity distribution according to the invention.

FIG. 13 is a side-sectional view of the exemplary illumination device of FIG. 12.

FIG. 14 is an end view of a sixth exemplary elongated illumination device having a uniform light intensity distribution according to the invention.

FIG. 15 is a side-sectional view of the exemplary illumination device of FIG. 14.

FIG. 16 through FIG. 18 are end views of additional exemplary elongated illumination devices having a uniform light intensity distribution according to the invention, having additional geometric profiles of focusing rods and diffusing rods.

### DETAILED DESCRIPTION OF EXEMPLARY EMBODIMENTS OF THE INVENTION

The present invention is an elongated illumination device for simulating an elongated tubular lamp having a uniform light intensity distribution along its length.

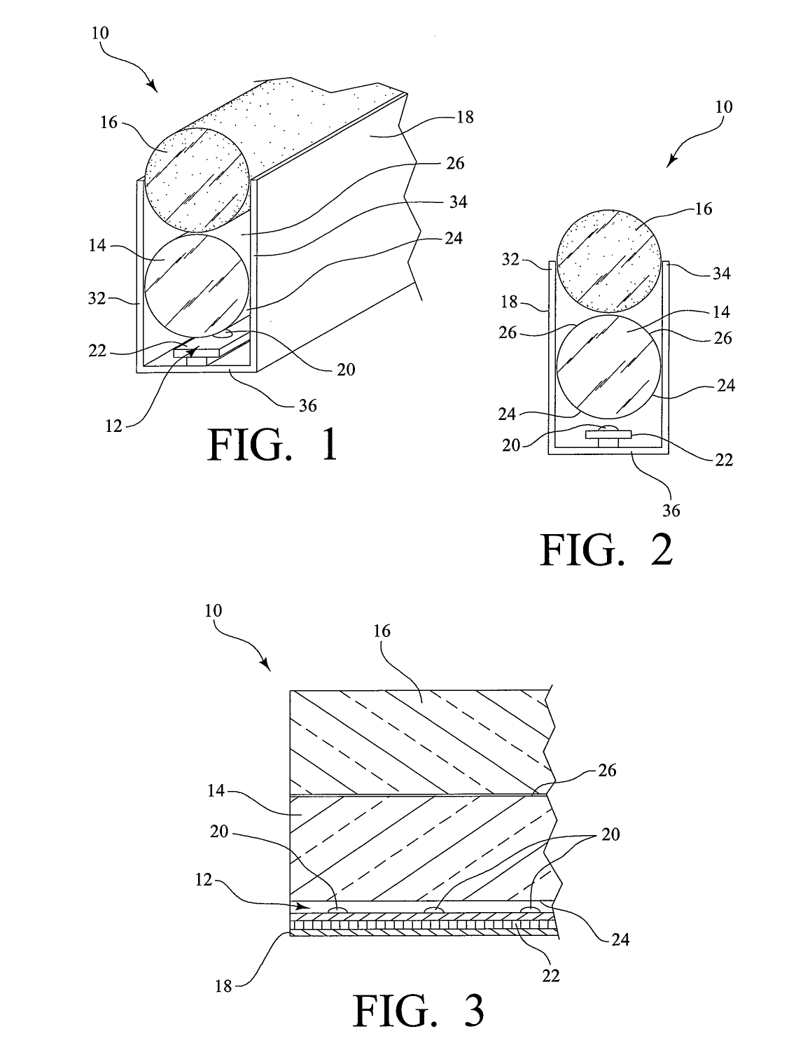

FIG. 1 through FIG. 3 show a first exemplary illumination device 10 in accordance with the present invention. As shown, the first exemplary illumination device 10 has an elongated array of point light sources 12, a focusing rod positioned adjacent to and along the elongated array of point light sources 12, a diffusing rod 16 positioned adjacent to and along the focusing rod 14, and a housing 18 positioned around the array of point light sources 12, the focusing rod 14, and the diffusing rod 16. In use, the array of point light sources 12 emits light into the focusing rod 14 which focuses the light into an elongated light distribution pattern and emits the focused light into the diffusing rod 16. The diffusing rod 16 diffuses the light into an essentially uniform light intensity distribution pattern along the length of the diffusing rod 16.

As used herein, the term “rod” should be understood to mean a slender, elongated member having a substantially consistent cross-sectional shape. Additionally, the length of the illumination device of the invention is indeterminate, as one of the characteristics of the elongated illumination devices that it simulates is variable length. Further, while shown as a straight assembly, it should be understood that, similar to neon lighting, the assembly can be fabricated into curved configurations for simulating script writing and intricate designs.

LEDs 20 serve as the point light sources for the array of point light sources 12 of the first exemplary illumination device 10. As discussed in U.S. Pat. Nos. 6,592,238 and 6,953,262, the recent introduction of lightweight, breakage resistant, high intensity LEDs provide many desirable characteristics for the simulation of neon or similar lighting. However, as point sources, such LEDs tend to have a hemispherical light emission pattern requiring focusing, reflection or other redirection for efficient simulation of an elongated illumination device. The elongated array of point light sources 12 of the first exemplary illumination device 10 is composed of a plurality of chip-on-board (COB) LEDs mounted on a circuit board 22, and spaced a pre-determined distance from one another along the length of the circuit board 22. More specifically, the COB LEDs of the first exemplary device 10 may be red-green-blue (RGB) LEDs, such as part number MTSP-617, manufactured by Marktech Optoelectronics of Latham, N.Y., spaced 0.6 inches on-center. One of skill in the art will recognize that other types of LEDs, means of physical positioning and electrical connection, and spacing are certainly within the spirit and scope of the claimed invention. However, COB LEDs are known to be much less expensive than other types of LEDs.

The focusing rod 14 serves as a lens to efficiently focus light emitted by the array of point light sources 12 into an elongated light distribution pattern. In the first exemplary device 10, the focusing rod 14 has a substantially circular cross-section. The focusing rod 14 has a light-receiving surface 24 and an opposed light-emitting surface 26. The focusing rod 14 is positioned such that the light-receiving surface 24 is adjacent to and along the array of point light sources 12 for receiving light emitted by the arrays of LEDs 12, focusing the light into an elongated light distribution pattern, and emitting the focused light along the light-emitting surface 26.

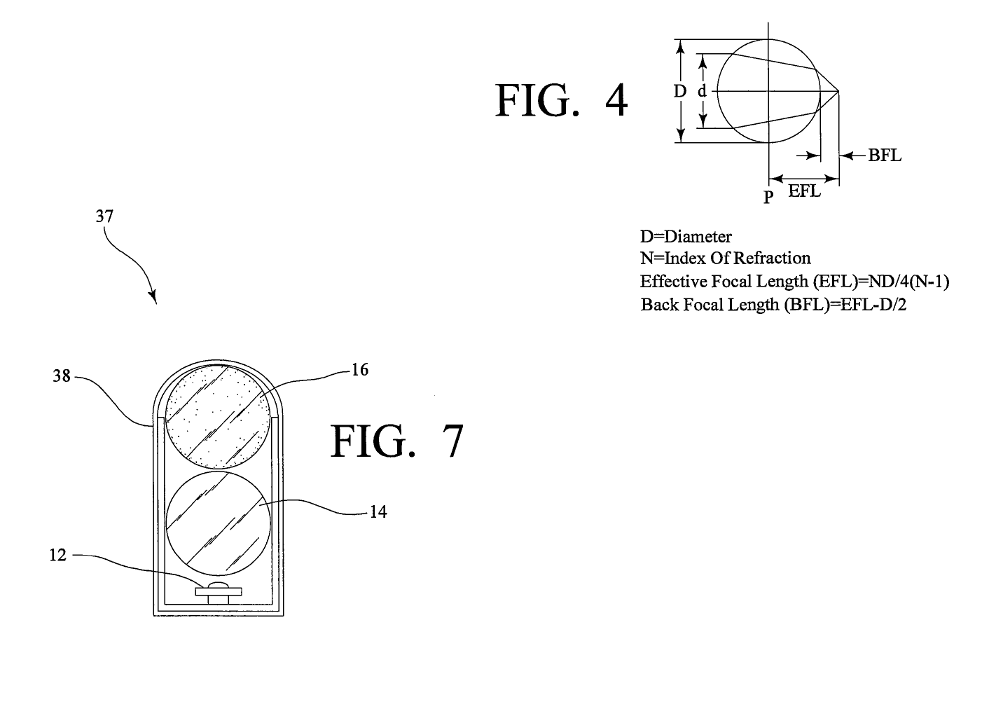

As a lens, the focusing rod 14 has a predetermined focal length. FIG. 4 illustrates how the focal length of a “ball lens” is calculated. Having a substantially circular cross-section, the “ball lens” formula is applicable to the cross-sectional geometry of the focusing rod 14. One of skill in the art will recognize that other cross-sectional geometric shapes, such as parabolic and ellipsoidal, may also be utilized in focusing light emitted by the array of point light sources 12 into an elongated light distribution pattern, without departing from the spirit or the scope of the claimed invention.

The focusing rod 14 of the first exemplary illumination device 10 is constructed of a substantially clear acrylic material having a diameter of 9.5 mm (⅜″). Using an index of refraction of 1.5 for clear acrylic material and the “ball lens” formula, the focal length of the focusing rod 14 is determined to be approximately 2.4 mm.

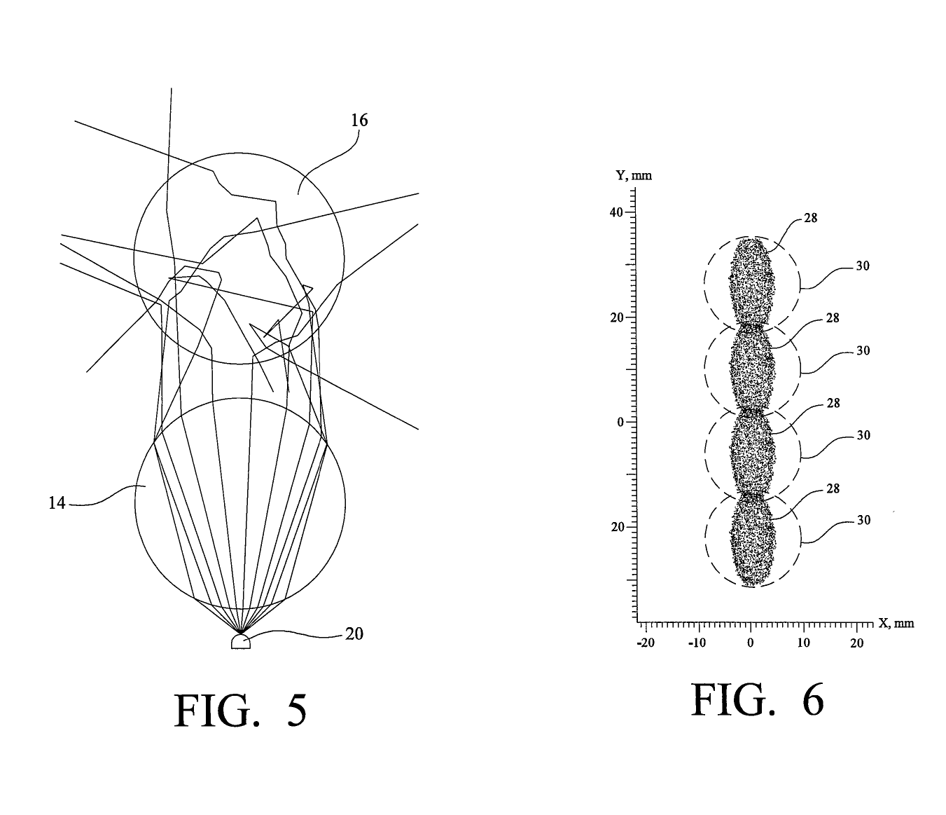

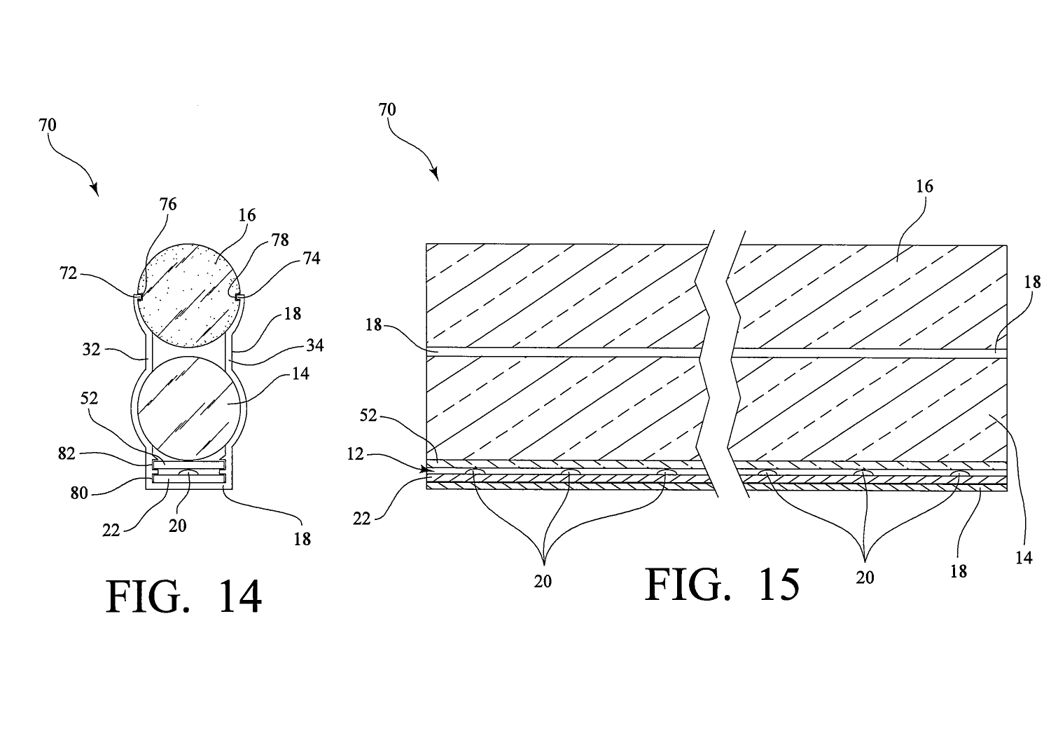

FIG. 5 is a ray trace diagram illustrating the focusing of light emitted by the LED 20 passing through the focusing rod 14. Preferably, the focusing rod 14 is spaced a distance substantially equal to the focal length of the focusing rod 14 (2.4 mm in the case of the exemplary focusing rod 14) from the array of point light sources 12. The housing 18 may be contoured (such as shown in FIG. 14) to hold the focusing rod 14 in place with respect to the array of point light sources 12, or spacers (not shown) may be utilized for this purpose.

FIG. 6 is a light distribution diagram illustrating the elongated light distribution pattern 28 emitted along the light-emitting surface 26 of the focusing rod 14 spaced a distance substantially equally to the focal length of the focusing rod 14 from the array of point light sources 12, as shown in FIG. 1 through FIG. 3. Advantageously, the lensing effect of the focusing rod 14 focuses the otherwise hemispherical light distribution patterns 30 of the individual LEDs 20 of the array of point light sources 12 into the elongated light distribution pattern 28. This is accomplished, as illustrated in FIG. 4 and FIG. 5, by the focusing rod 14 bending light emitted in a more lateral or side direction (perpendicular to the axis of the rod) back toward the axis of the rod, while allowing light emitted in a more axial direction to continue to propagate in the axial direction.

Returning now to FIG. 1 through FIG. 3, the diffusing rod 16 is positioned adjacent to and along the focusing rod light-emitting surface 26 for receiving the focused light emitted by the focusing rod 14. The diffusing rod 16 is for diffusing or scattering the received light into an essentially uniform light intensity distribution pattern, and emitting said diffused light. The phrase “essentially uniform light intensity distribution pattern” should be understood to mean the even light distribution over the length and about the circumference of the diffusing rod 16, such as is characteristic of neon tube lighting and tubular fluorescent lamps. Thus, the essentially uniform light intensity distribution pattern should be understood to apply to both the appearance of the diffusing rod 16, as in neon tube lighting for signage, as well as the distribution of the light emitted by the diffusing rod 16, as in tubular fluorescent lighting for general task illumination. Thus, the diffusing rod 16 will have a substantially even glow over its entire length and about its circumference.

The diffusing rod 16 of the first exemplary illumination device 10 also has a substantially circular cross-section having a diameter of 9.5 mm, although other geometries (such as those shown in FIG. 14 through FIG. 17) may be employed without departing from the spirit or scope of the invention. Preferably, the diffusing rod 16 is made of a “leaky” waveguide material, such as the optical waveguide and light scattering member described in U.S. Pat. Nos. 6,592,238 and 6,953,262. An example of such a material is a 100% frosted DR acrylic, such as is available from Arkema Inc., of Philadelphia, Pa. As an optical waveguide, the material tends to preferentially direct light entering the material along an axial direction, while as a light scattering member, it urges light out of its surfaces with a substantially uniform light intensity distribution. Of course, other diffusing materials could be used without departing from the spirit and scope of the invention.

The ray trace diagram of FIG. 5 illustrates the diffusing rod 16 diffusing or scattering focused light received from the focusing rod 14. Thus, the diffusing rod 16 has an even glow over its entire length and around its entire circumference.

Advantageously, the circular extrusion profile for the focusing rod 14 and the diffusing rod 16 of the first exemplary illumination device 10 allows for easier and less costly manufacturing, since it is simpler to make an extrusion tool that has a round profile, than other, more complex profiles. Additionally, by allowing the illumination device 10 to have a narrower width, the circular profile focusing rod 14 and diffusing rod 16 also allow the illumination device 10 to have a “shorter” profile or height than other, prior art devices.

Returning again to FIG. 1 through FIG. 3, the housing 18 generally comprises a pair of parallel, spaced side walls 32, 34 and a bottom wall 36 connecting a bottom portion of the side walls 32, 34. The side walls 32, 34 and bottom wall 36 define an open-ended channel in which the array of point light sources 12, focusing rod 14 and diffusing rod 16 are received. Each of the side walls 32, 34 and bottom wall 36 has an interior surface facing the channel, and an exterior surface facing away from the channel. Advantageously, the diffusing rod 16 protrudes at least partially from the channel and has an even glow for simulating the appearance of a surface of a tubular lamp.

Furthermore, it should be recognized that the housing 18 may not only function to house the various components, but also to collect light not emitted directly into the focusing rod 14 and light emitted from the diffusing rod 16 back into the channel, and to redirect that light into the focusing rod 14 and the diffusing rod 16. As such, the interior surfaces of the side walls 32, 34 and the bottom wall 36 may be constructed of or coated with a light-reflecting material (e.g. white paint or tape) in order to increase the light collection efficiency by redirecting light incident upon the interior surfaces of the housing 18 into the focusing rod 14 and the diffusing rod 16. Similarly, the surface of the circuit board 22 may be reflective.

As a further refinement, from a viewer's perspective, it is desirable that the visual appearance of the housing 18 not be obtrusive with respect to the glowing, diffusing rod 16. Therefore, the exterior surfaces of the housing 18 may be constructed of or coated with a light-absorbing material (e.g., black paint or tape).

FIG. 7 shows a second exemplary elongated illumination device in which the device is encased in a sleeve 38 to maintain the positions of the components relative to one another. The sleeve 38 is made of a light-transmitting flexible plastic material, such as polycarbonate. Advantageously, the sleeve 38 may be sealed at the ends of the illumination device, or end caps may be utilized, allowing the illumination device to be made air-tight, or water-tight and submersible.

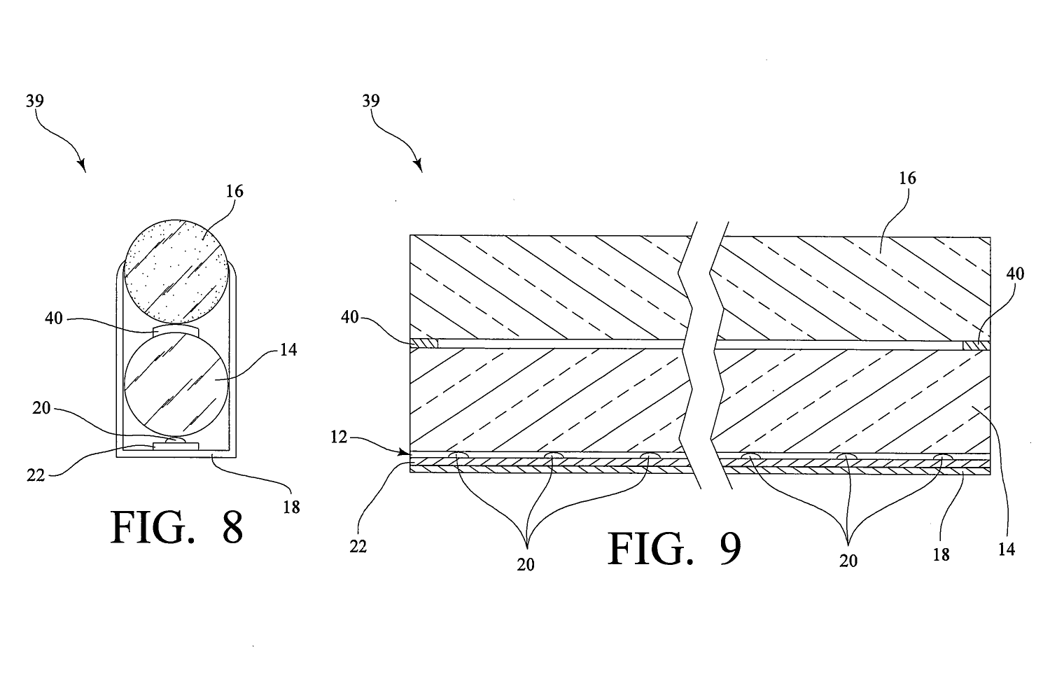

FIG. 8 shows a third exemplary elongated illumination device 39 having a spacer member 40 positioned between the focusing rod 14 and the diffusing rod 16. A representative spacer member 40 is a 0.060 inch thick piece of double-sided white tape such as Double-Coated Foam Tape made by 3M Company. Preferably, only short sections of the tape are used at the ends of the first exemplary device 10. Advantageously, a spacer member 40 having double-sided adhesive properties serves to hold the focusing rod 14 and the diffusing rod 16 together.

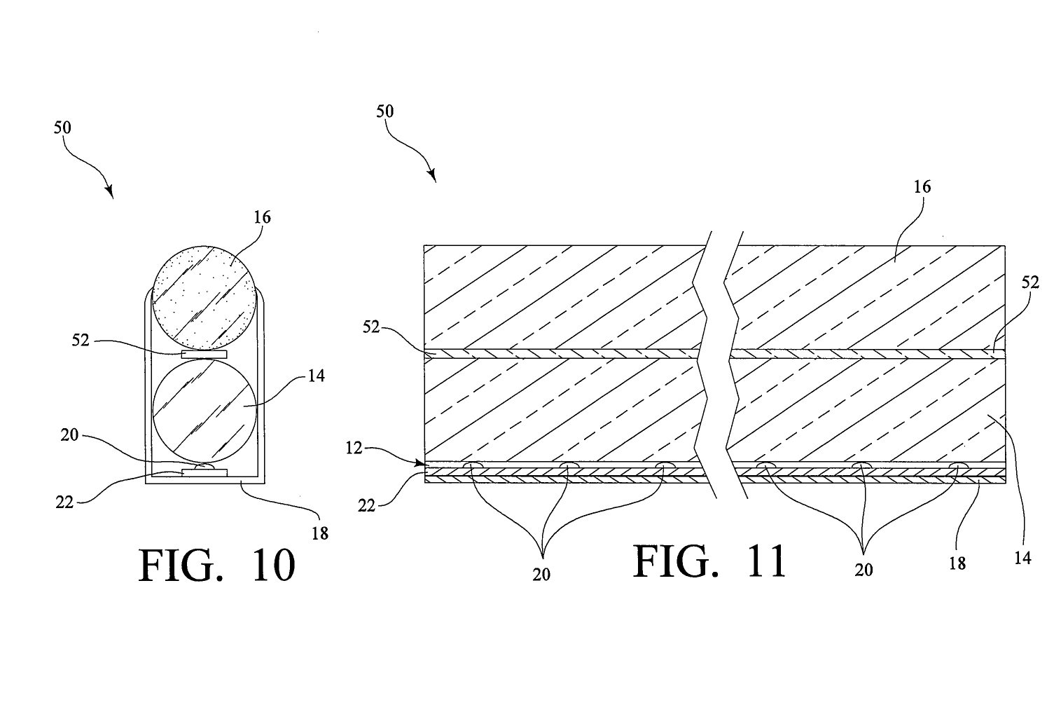

FIG. 10 and FIG. 11 show a fourth exemplary illumination device 50 according to the invention. The second exemplary illumination device 50 has an elongated array of point light sources 12, a focusing rod 14, a diffusing rod 16, a housing 18, and a color-converting member 52. The general configuration of the elements of the second exemplary illumination device 50 is similar to the configuration of the first exemplary illumination device 10 (FIG. 1 through FIG. 3), with the addition of the color-converting member 52 between the focusing rod 14 and the diffusing rod 16. LEDs 20 serve as the point light sources of the array of point light sources 12, and are for emitting at least a light of a first color. The focusing rod 14 is for focusing the light of the first color into an elongated light distribution pattern. The color-converting member 52 intercepts at least a portion of the light of the first color emitted by the focusing rod 14 and converts it to a light of a second color.

The color-converting member 52 is composed of a matrix of substantially translucent material, such as Frosted DR Acrylic (described above) doped with a color-converting material, such as a fluorescent Lumogen® F240 dye, by BASF Aktiengesellschaft, of Ludwigshafen, Germany. The LEDs 20 emit light of at least a first color (such as blue, around 470 nm), and the color-converting member 52 converts at least a portion of the light emitted by the focusing rod 14 into a light of a second color for emission into the diffusing rod 16.

Of course, other materials for the color-converting member 52 and the color-converting material may be utilized for within the spirit and scope of the claimed invention. For instance, a simple color-filtering material could be utilized in place of fluorescent or phosphorescent dyes and pigments. However, fluorescent and phosphorescent dyes and pigments are preferred as they are more efficient at converting the color of light.

The diffusing rod 16 receives and mixes the light of the first color and the light of the second color to create a perceived light of a combined color. By changing the density of the color-converting material in the color-converting member 52 as well as the amount of light that the color-converting member 52 intercepts, the color of the light emitted by the diffusing rod 16 may be varied.

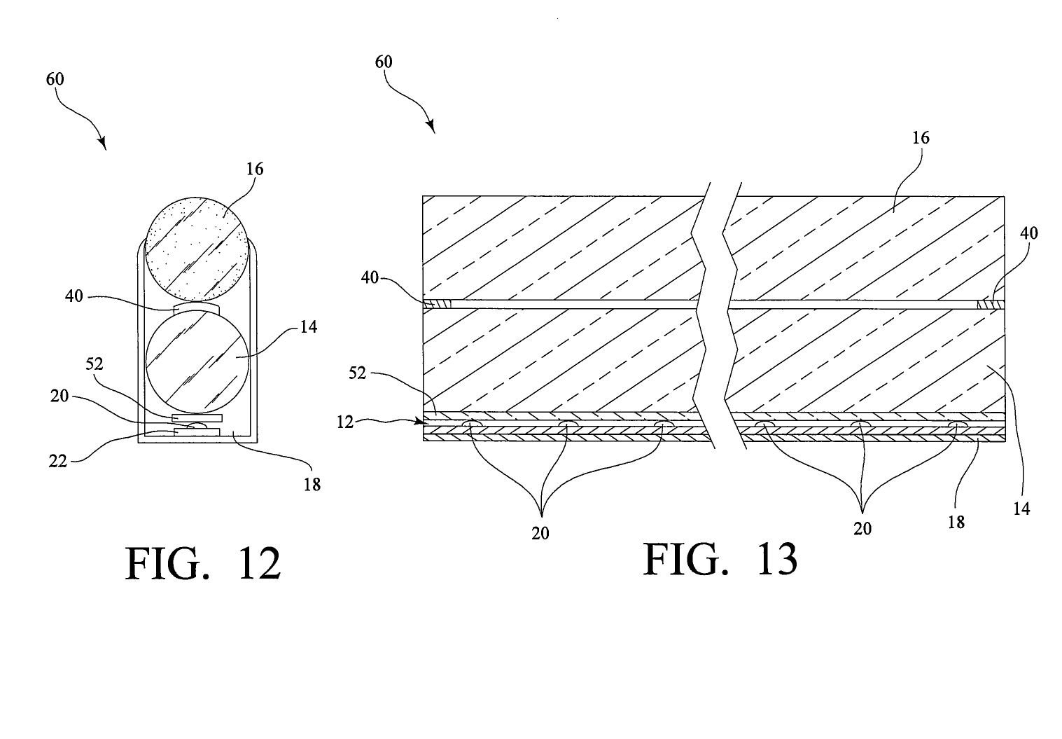

FIG. 12 and FIG. 13 show a fifth exemplary illumination device 60 according to the invention. The third exemplary device 60 has an elongated array of point light sources 12, a focusing rod 14, a diffusing rod 16, a housing 18, a spacer member 40, and a color-converting member 52.

LEDs 20 are the point light sources of the array of point light sources 12. The LEDs 20 are for emitting a light of a first color.

The spacer member 40 is positioned between the focusing rod 14 and the diffusing rod 16 and may be double-sided white foam tape. Preferably, only short pieces of tape are attached at the ends of the illumination device 60 for holding the focusing rod 14 and the diffusing rod 16 together, so as to not significantly block the transfer of light between the focusing rod 14 and the diffusing rod 16.

The color-converting member 52 is positioned between the array of point light sources 12 and the focusing rod 14 for intercepting a portion of a light of a first color emitted by the LEDs 20 and converting a portion of the intercepted light of the first color into a light of a second color. As described above, the color-converting member 52 is a matrix of substantially translucent material doped with a color-converting material, such as fluorescent or phosphorescent dye.

The focusing rod 12 is for receiving the light of a second color and any light of a first color that was not intercepted or converted by the color-converting member 52, and focusing such light into an elongated light distribution pattern. The diffusing rod 14 is for receiving the light of a second color and any light of a first color from the focusing rod 12, mixing such light to create a perceived light of a combined color, and diffusing the perceived light of a combined color into an essentially uniform light intensity distribution pattern.

By controlling the density of the color-converting material of the color-converting member 52 and the amount of light intercepted by the color-converting member 52, the perceived color of the light can be adjusted.

FIG. 14 and FIG. 15 show a sixth exemplary illumination device 70 according to the invention. Similar to the third exemplary illumination device 60, the fourth exemplary illumination device 70 also has an elongated array of point light sources 12, a focusing rod 14, a diffusing rod 16, a housing 18, and a color-converting member 52. However, the fourth exemplary illumination device 70 does not have a spacer member 40 (FIG. 12 and FIG. 13) because the housing 18 is contoured to hold the array of point light sources 12, the focusing rod 14, the diffusing rod 16 and the color-converting member 52 in position with respect to each other.

Each of the housing side walls 32, 34 has an inwardly projecting lip 72, 74 that cooperates with a corresponding longitudinal groove 76, 78 in the diffusing rod 16 to hold the diffusing rod 16 in place without the use of adhesives or the like. Further, a circuit-board slot 80 and a color-converting member slot 82 may be formed in a lower interior portion of each housing side wall 32, 34 for receiving and holding the circuit board 22 and the color-converting member 52, also without the use of adhesives or the like.

It should be further noted that a similar slot (not shown) may be formed at an intermediate interior position to hold a color-converting member between the focusing rod 14 and the diffusing rod 16, if positioning a color-converting member at such a location is desired. Additionally, the principle of the contoured housing 18 for holding

Further, with respect to the embodiments described herein, it should be noted that the focusing rod 14 may also be doped with a color-converting material, such as Lumogen® F 305 Red fluorescent dye. Thus, the perceived color of light emitted by the diffusing rod 16 may be further adjusted by utilizing a color-converting material within the structure of the focusing rod 14.

Still further, the LEDs 20 in each of the embodiments described herein may be red-green-blue (RGB) LEDs attached to a control circuit for varying the color output of the RGB LEDs and allowing further adjustment of the color of light emitted by the exemplary illumination devices. However, the use of RGB LEDs and a control circuit adds cost and complexity to the illumination device, which can be advantageously avoided through the appropriate selection of single color LEDs and appropriate color-converting materials for use in a color-converting member 52 and/or the focusing rod 14.

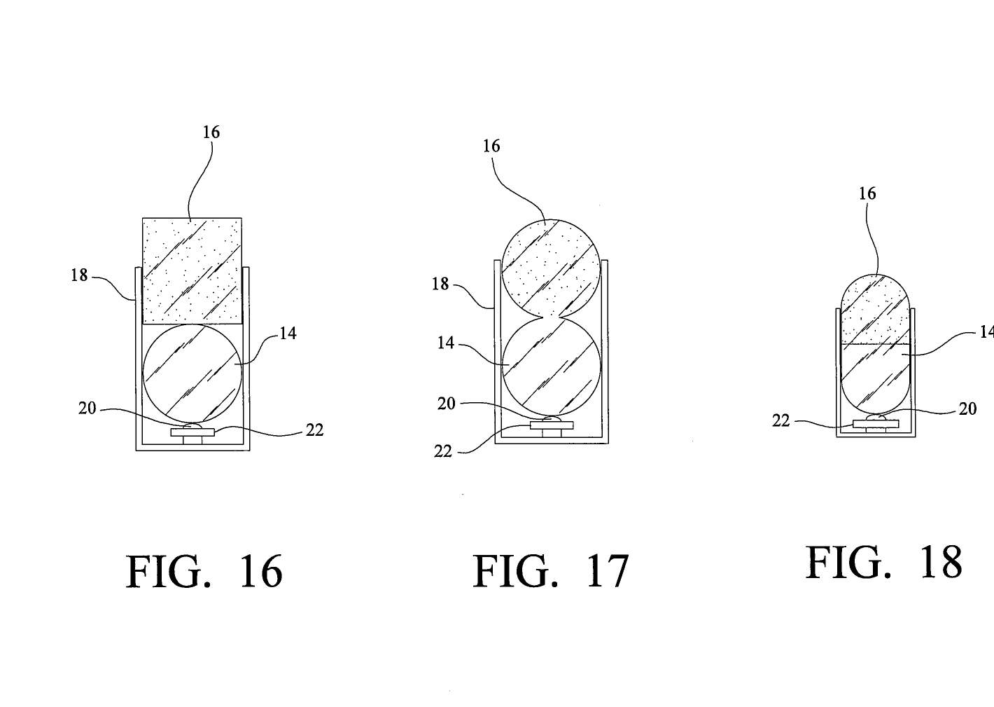

FIG. 16 through FIG. 18 show additional geometric profiles of focusing rods 14 and diffusing rods 16 that should be considered equivalent structures and within the scope of the invention claimed herein. FIG. 16 shows a diffusing rod 16 having a substantially rectangular cross-section. FIG. 17 and FIG. 18 show a focusing rod 14 and a diffusing rod 16 formed as a unitary assembly, such as by co-extrusion of the distinct materials used for each element. The ability to co-extrude the focusing rod 14 and diffusing rod 16 provides another manufacturing convenience, and also allows for easier bending of the assembly for adding curves for simulating script writing and intricate designs.

In any event, an illumination device made in accordance with the present invention provides many advantages and benefits, including simplified manufacturing as compared to techniques for manufacturing prior art devices.

One of ordinary skill in the art will also recognize that additional embodiments are possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. An elongated illumination device having a uniform light intensity distribution, comprising:
an elongated array of point light sources spaced a predetermined distance from one another;
a focusing rod having a light-receiving surface and an opposing light-emitting surface, said focusing rod positioned such that said light-receiving surface is adjacent and along said array of point light sources for receiving light emitted by said array of point light sources, focusing said light into an elongated light distribution pattern, and emitting said focused light along said light-emitting surface; and
a diffusing rod positioned adjacent to and along said light-emitting surface for receiving light emitted along said light-emitting surface, diffusing said light into an essentially uniform light intensity distribution pattern, and emitting said diffused light.

2. The elongated illumination device of claim 1, wherein each of said focusing rod and said diffusing rod have a substantially circular cross-section.

3. The elongated illumination device of claim 1, wherein said focusing rod has a predetermined focal length, said focusing rod being spaced a distance substantially equal to said predetermined focal length from said array of point light sources.

4. The elongated illumination device of claim 1, further comprising a housing having a pair of side walls and a bottom wall connecting said side walls, said side walls and bottom wall defining a channel in which said array of point light sources, said focusing rod, and said diffusing rod are received, said diffusing rod protruding from said channel for simulating a surface of a tubular lamp.

5. The elongated illumination device of claim 4, wherein said side walls have an interior surface facing an interior of said channel and an exterior surface facing away from said channel, said side wall interior surfaces being reflective for redirecting incident light from said array of point light sources into said focusing rod, said side wall exterior surfaces being substantially light-absorbing.

6. The elongated illumination device of claim 4, wherein said LEDs are mounted on a circuit board, said circuit board being reflective for further directing light into said focusing rod.

7. The elongated illumination device of claim 4, further comprising a sleeve encasing said housing and said diffusing rod to maintain said array of point light sources, said focusing rod, said diffusing rod and said housing relative to one another, said sleeve made of a light-transmitting material.

8. The elongated illumination device of claim 4, further comprising a spacer member positioned between said focusing rod and said diffusing rod.

9. The elongated illumination device of claim 4, further comprising a color-converting member composed of a matrix of substantially translucent material doped with a color-converting material, wherein light-emitting diodes (LEDs) are the point light sources of said array of point light sources, said LEDs for emitting a light of a first color, said color-converting member positioned between said array of point light sources and said diffusing rod for intercepting a portion of said light of said first color and converting at least a portion of said intercepted light to a light of a second color, said diffusing rod for emitting diffused light of a color that is a combination of said light of said first color and said light of said second color.

10. The elongated illumination device of claim 9, wherein said color-converting member is positioned between said focusing rod and said diffusing rod.

11. The elongated illumination device of claim 9, wherein said color-converting member is positioned between said array of point light sources and said focusing rod.

12. The elongated illumination device of claim 11, further having a spacer member positioned between said focusing rod and said diffusing rod, said spacer member having double-sided adhesive properties for holding said focusing rod and said diffusing rod together.

13. The elongated illumination device of claim 1, wherein said housing side walls are contoured to hold said array of point light sources, said focusing rod, and said diffusing rod in position with respect to each other.

14. The elongated illumination device of claim 1, wherein said focusing rod is doped with a color-converting material, wherein light-emitting diodes (LEDs) are the point light sources of said array of point light sources, said LEDs for emitting a light of a first color, wherein said focusing rod is for receiving said light of said first color, converting at least a portion of said light of said first color to a light of a second color, focusing said light of said first color and said light of said second color into said elongated light distribution pattern, and emitting said focused light along said light-emitting surface.

15. An illumination device for simulating an elongated tubular lamp having a uniform light intensity distribution, said illumination device comprising:
an elongated array of light-emitting diodes (LEDs) for emitting light of a first color;
a focusing rod having a light-receiving surface and an opposing light-emitting surface, said focusing rod positioned such that said light-receiving surface is adjacent and along said array of LEDs for receiving said light emitted by said array of LEDs, focusing said light into an elongated light distribution pattern, and emitting said focused light along said light-emitting surface;
a diffusing rod positioned adjacent to and along said focusing rod light-emitting surface for receiving said focused light, diffusing said focused light into an essentially uniform light intensity distribution pattern, and emitting said diffused light;
a color-converting member composed of a matrix of substantially translucent material doped with a color-converting material, said color-converting member positioned between said array of LEDs and said diffusing rod, said color-converting member for receiving said light of said first color, converting a portion of said light of said first color into a light of a second color, and emitting a light of a color that is a combination of said first color and said second color; and
a housing having a pair of side walls and a bottom wall connecting said side walls, said side walls and bottom wall defining a channel in which said array of LEDs, said focusing rod, said diffusing rod, and said color-converting member are received, said diffusing rod protruding from said channel, said side walls being contoured to hold said array of LEDs, said color-converting member, said focusing rod, and said diffusing rod in position with respect to each other.

16. The elongated illumination device of claim 15, wherein each of said focusing rod and said diffusing rod have a substantially circular cross-section.

17. The elongated illumination device of claim 16, wherein said focusing rod is doped with a different color-converting material.
